(19) United States
(12) Patent Application Publication
(10) Pub. No.: US 2011/0204648 A1
(43) Pub. Date: Aug. 25, 2011

(54) WINDMILL WITH BLADES WITH PASSAGEWAYS FROM HUB TO TIP

(76) Inventor: Roger D. Wilson, Boise, ID (US)

(21) Appl. No.: 12/968,270

(22) Filed: Dec. 14, 2010

Related U.S. Application Data
(60) Provisional application No. 61/286,304, filed on Dec. 14, 2009.

(51) Int. Cl. F03D 11/02; F03D 9/00

(52) U.S. Cl. 290/55; 416/91

(57) ABSTRACT

The present invention is a windmill with blades with passageways for air to move radially outward from near the hub of the windmill to near the tip of the blades. It is thought that the centrifugal force from rotation of the blades will draw or force air into open passageways near the hub of the windmill, and throw the air out forcefully from openings near the tips of the blades. This way, an additional flow of air in or next to and along the blades is created by the rotating additional blades. This additional air flow may be used to move additional generator devices, for example, turbines in an interior space of the windmill support tower, or near the hub of the windmill, or near the tips of the blades. In one embodiment, a funnel shroud near the windmill hub directs additional air from the windward side of the windmill into the proximal end of the passageway near or around the windmill hub.

This application claims benefit of U.S. Provisional Application Ser. No. 61/286,304, filed Dec. 14, 2009, the entire disclosure of which is incorporated herein by this reference.

### BACKGROUND OF THE INVENTION

1. Field of the Invention

This invention relates generally to windmills, especially windmills for generating electricity. More specifically, this invention relates to windmills with blades with passageways for air to move radially outward from near the hub of the windmill to near the tips of the blades during rotation of the blades.

2. Related Art

U.S. Pat. No. 4,205,943 (Vauthier) discloses a hydroelectric generator with open-ended hollow tubes having influx ends proximate the axis and efflux ends proximate the periphery of a fan-bladed turbine. Additional turbines at the efflux ends of the blades receive water directed from the hollow tubes near the axis to spin the turbines, and provide additional generation capacity.

### SUMMARY OF THE INVENTION

The present invention is a windmill with blades with passageways for air to move radially outward from near the hub of the windmill to near the tip of the blades. It is thought that the centrifugal force from rotation of the blades will draw or force air into open passageways near the hub of the windmill, and throw the air out forcefully from openings near the tips of the blades. This way, an additional flow of air, besides the conventional flow of air past the blades, in or next to and along the blades is created by the rotating blades. This additional air flow may be used to move additional generator devices, for example, additional turbines in an interior space of the windmill support tower, or near the hub of the windmill, or near the tips of the blades.

### BRIEF DESCRIPTION OF THE DRAWINGS

FIG. 1 is a front, cross-sectional, schematic view of one embodiment of the invention with an additional turbine and generator apparatus vertically oriented within the hollow support tower for the horizontal-axis windmill.

FIG. 2 is a top, perspective view of the embodiment depicted in FIG. 1.

FIG. 3 is a side view of the embodiment depicted in FIG. 1.

FIG. 4 is a slightly enlarged, partial top view of the embodiment depicted in FIG. 1.

On page 5 of the drawings is a series of figures, FIGS. 5A-5F, which depict several different cross-sectional, detail views of a windmill embodiment of the invention.

On page 6 of the drawings is a series of figures, FIGS. 6A-6E, which depict several different cross-sectional, detail views of a turbine blade embodiment of the invention.

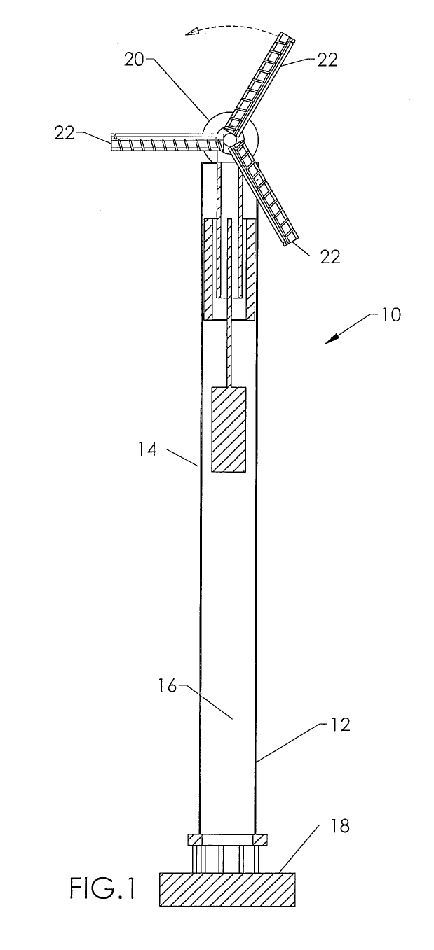

On page 7 of the drawings is a series of schematic figures, FIGS. 7A, 7A-1, 7B, 7B-1 and 7C, which depict several different overall and cross-sectional, detail views of an alternate windmill embodiment of the invention.

### DESCRIPTION OF THE PREFERRED EMBODIMENTS

In the drawings are depicted several, but not all, embodiments of the present invention.

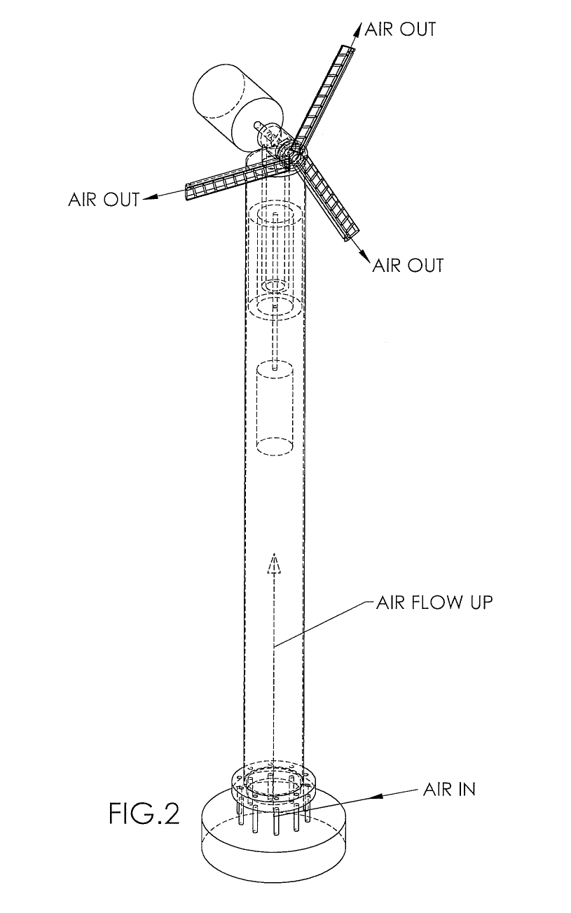

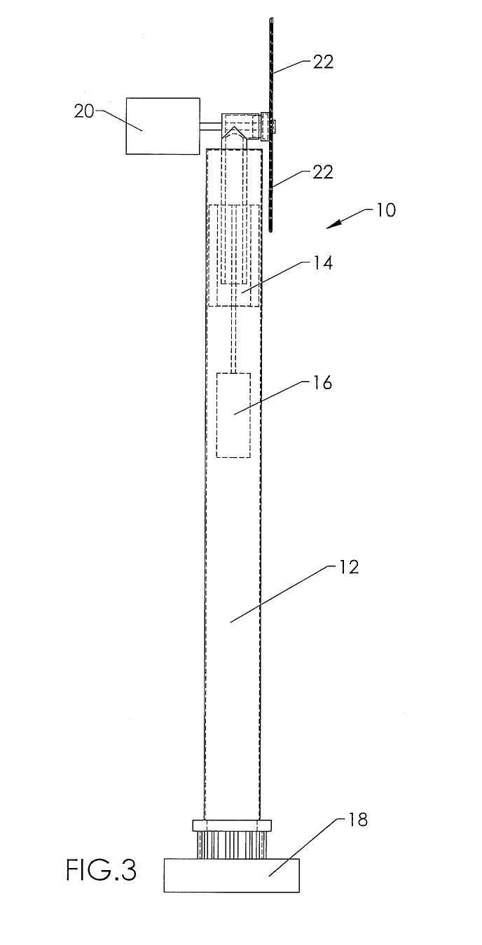

FIG. 1 is a front, cross-sectional, schematic view of a horizontal-axis windmill 10 on a vertical support tower 12 with turbine generator 20, according to an embodiment of the invention. As depicted in FIGS. 1-4, support tower 12 is hollow, and has an additional turbine 14 and generator 16 positioned inside it. At or near its base 18, the inside volume of tower 12 is open to the atmosphere. This way, air from outside the tower will be drawn into the tower by any lower pressure or vacuum inside the tower.

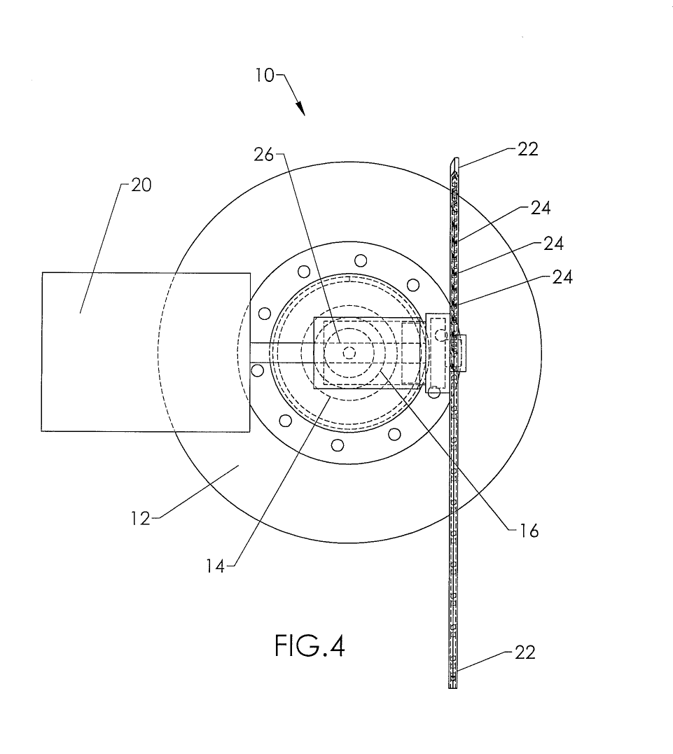

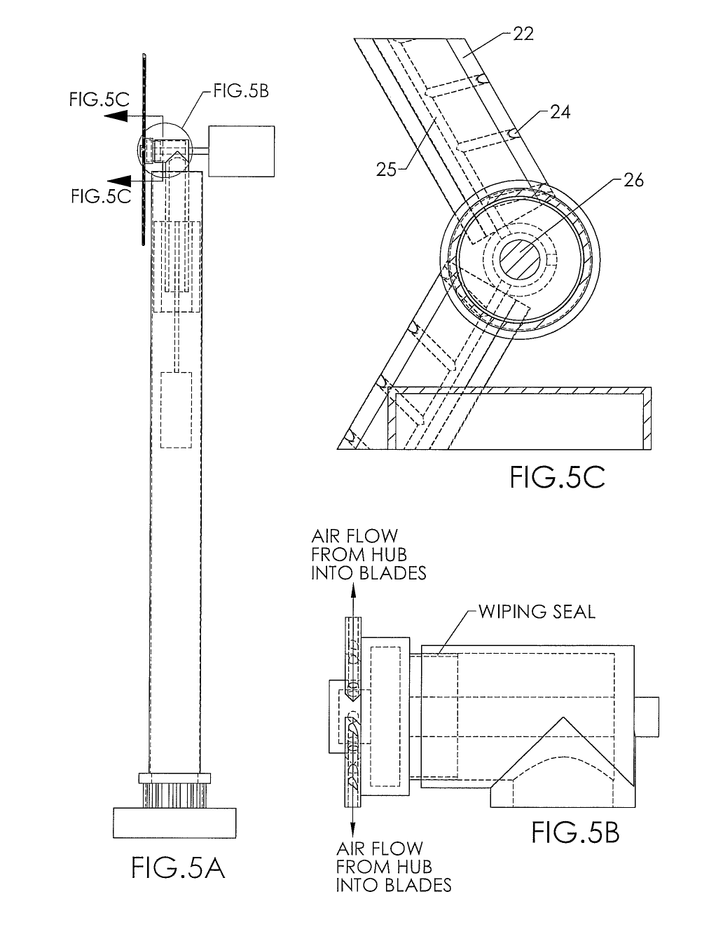

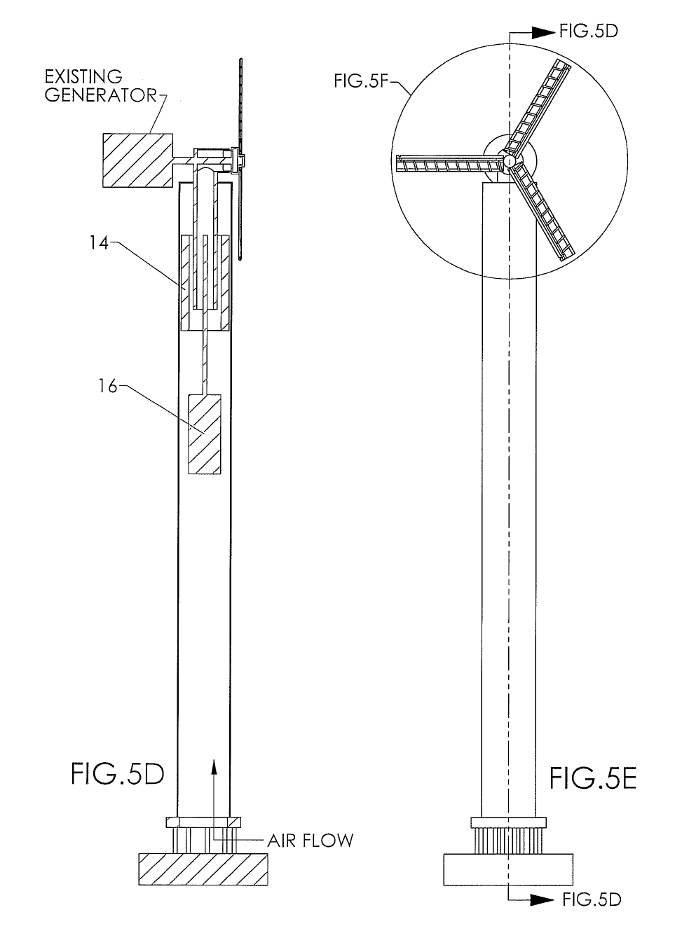

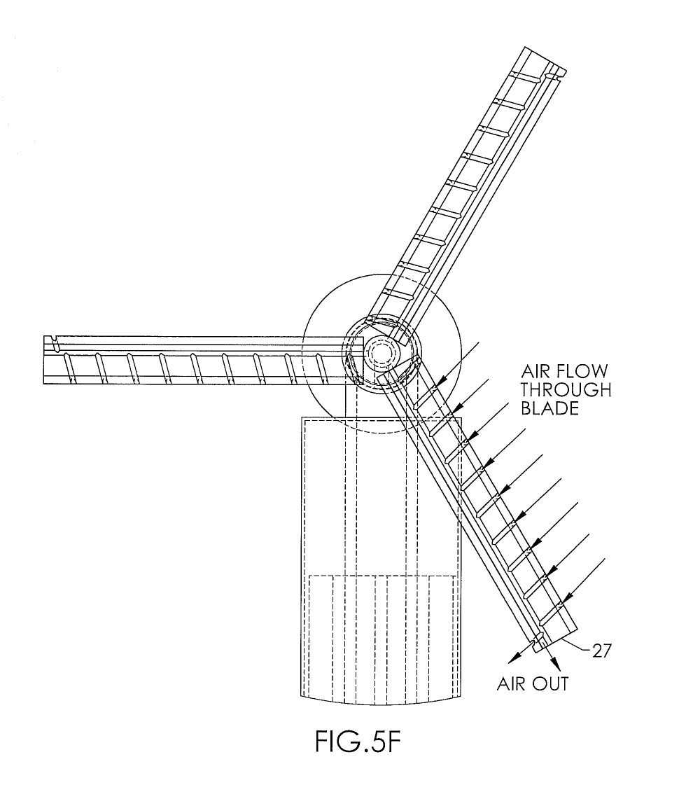

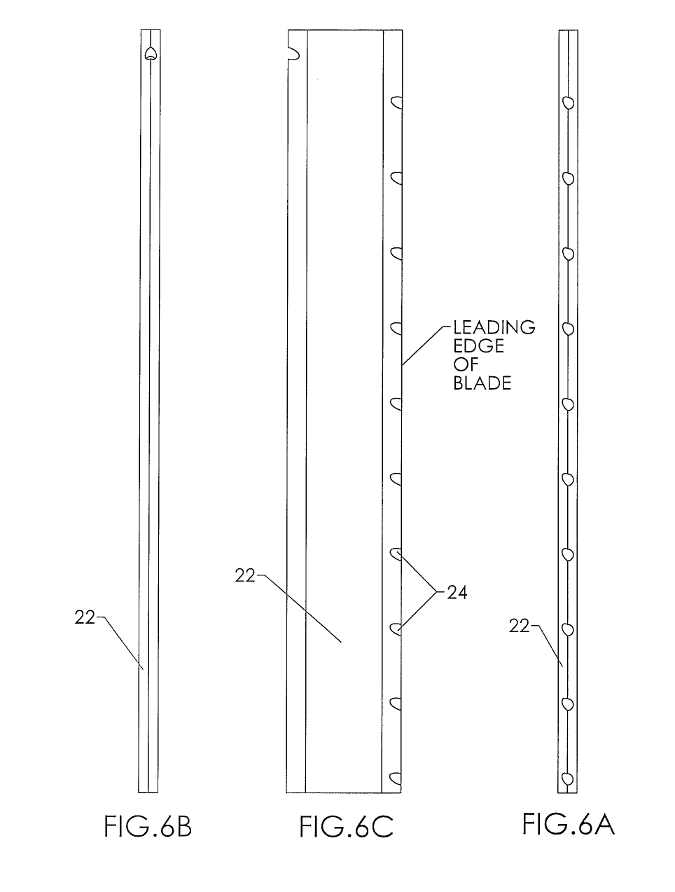

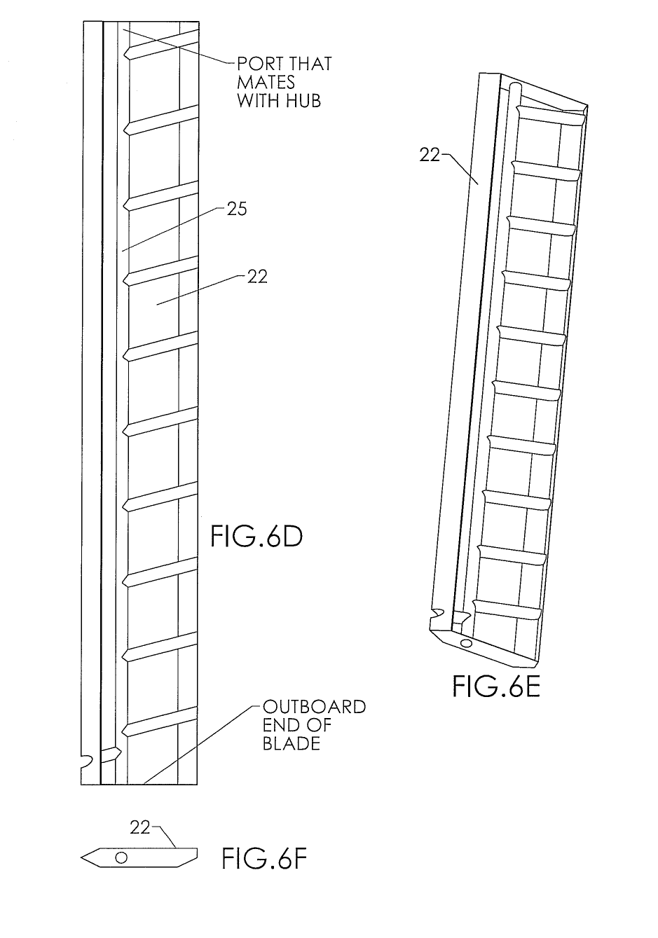

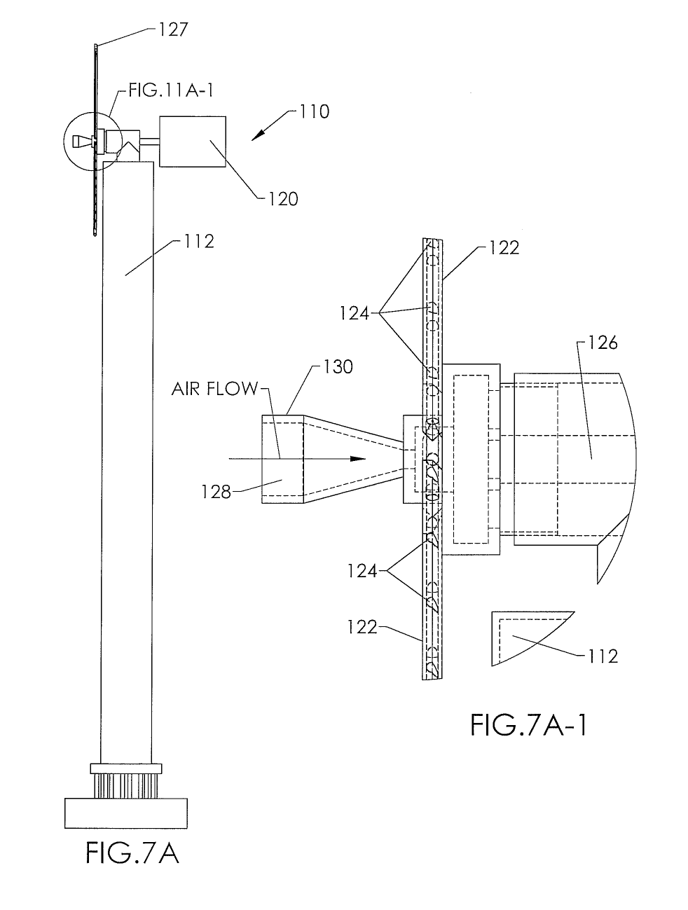

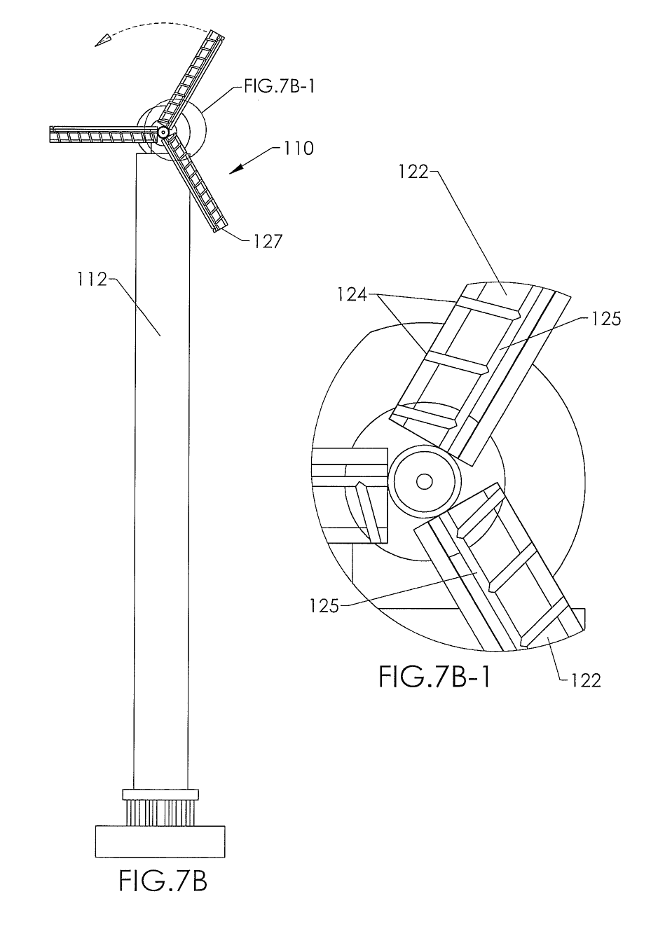

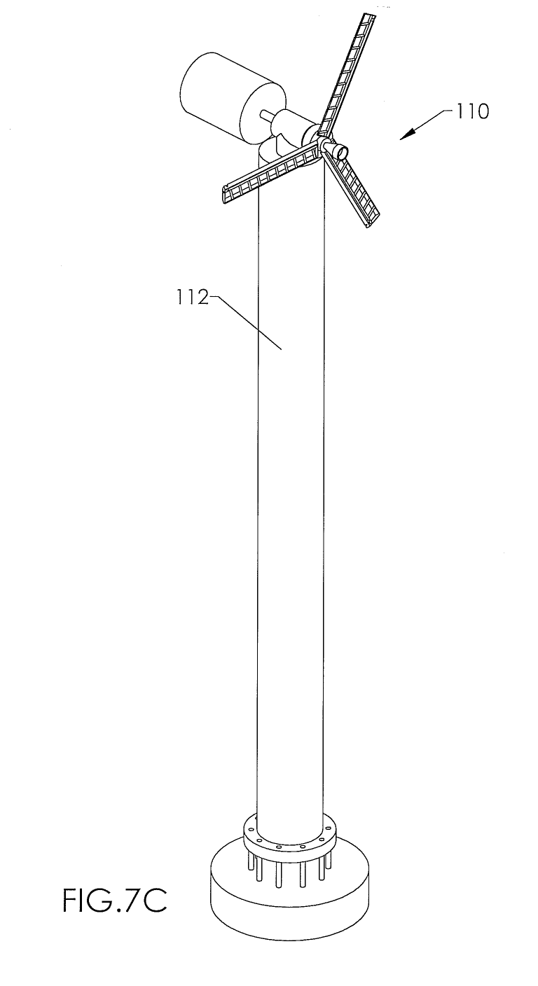

Turbine blades 22 of windmill 10 have holes 24 preferably on or near the leading edge of the blade, as depicted in FIGS. 4 and 5A-5F. Holes 24 are operatively connected to passageway 25 in or on the blade. Preferably, passageway 25 extends radially outward from at or near the windmill hub 26 out to or near the distal end 27 of blade 22. From near the distal end of the blade, passageway 25 extends out into the atmosphere. This way, air moved into holes 24 travels into passageway 25 and radially outward towards the distal end 27 of blade 22, and from there, out into the atmosphere. A plurality of holes 24 may be provided in blade 22. Preferably, in this embodiment passageway 25 extends at its proximal end into the interior hollow space of support tower 12. This way, the flow of air into holes 24 and radially outward through passageway 25 creates a low pressure or vacuum in passageway 25 at or near hub 26 of the windmill, and consequently in or near the top of the interior space of tower 12. Alternatively, passageway 25 may be a conduit secured to one or more sides or edges of blade 22, as depicted in FIGS. 7-10. This way, passageway 25 extends “along” blade 22, instead of “through” blade 22, as described above.

Tower 12 has an interior space which is in air flow cooperation with passageway 25 for each blade 22 that has a passageway. Preferably, passageway 25 extends through an interior space of hub 26 into the top of the interior space of tower 12. A conventional wiping seal, like a labyrinthian seal for example, between the passageways of the rotating blades and the hub interior space will preserve the low pressure or vacuum in the tower 12's interior space created by the out-flowing air from the distal tips of the rotating blades. In addition, the interior space of hub 26 is also in sealed air flow cooperation with the interior space of tower 12. This way, the air moving outwardly in all the connected passageways 25 causes low pressure or vacuum, and encourages air to move vertically upward within the interior space of tower 12. This vertically moving air in interior space 12 is available to turn additional turbine 14 and additional generator 16, for example, resulting in additional generating capacity overall for windmill 10.

More detail views of a turbine blade 22 are depicted in FIGS. 6A-6E. From these detail views it is clear that blade 22 has holes that operatively connect with passageway 25, passageway 25 extending all the way from near the hub to the distal (outboard) end of blade 22. At the distal end of blade 22, the exit of passageway 25 may be angled. Also, additional turbines may be placed near or at the exit of passageway 25, in order to effectively take advantage of the energy in the air exiting therefrom.

FIG. 7A is a side view of one alternate embodiment of the invention. FIG. 7B is a front view of the embodiment depicted in FIG. 7A. FIG. 7A-1 is a detailed, cross-sectional view of the circled area in FIG. 7A. FIG. 7B-1 is a detailed cross-sectional view of the circled area in FIG. 7B. FIG. 7C is a top perspective view of the alternative embodiment of the invention depicted in FIGS. 7A and 7B.

In FIG. 7A-1, horizontal windmill 110 has turbine generator 120 mounted near the top of support tower 112. Turbine blades 122 of windmill 110 have holes 124 preferably on or near the leading edge of the blade. Holes 124 are operatively connected to passageway 125 in the blade, as depicted in FIG. 7B-1. Preferably, passageway 125 extends radially outward from at or near windmill hub 126 out to or near the distal end 127 of blade 122. From near the distal end of the blade, passageway 125 extends out into the atmosphere. This way, air moved into holes 124 travels into passageway 125 and radially outward towards the distal end 127 of blade 122, and from there, out into the atmosphere. A plurality of holes may be provided in blade 122. Preferably, in this embodiment passageway 125 extends at its proximal end into an open space 128 at the windward side of the hub 126. Open space 128 is created by a funnel shroud 130 which directs inlet air from the windward side of the windmill into the proximal end of passageway 125 near or around windmill hub 126. This way, it is thought that the additional flow of air radially outward through passageway 125 will provide additional turning force on the blade 122, and additional torque on hub 126, adding additional generating capacity to turbine generator 120. Alternatively, an additional turbine generator, for example, one co-axial with generator 120, may be placed inside the funnel shroud 130 to provide additional generating capacity therein.

Some embodiments of the invention may be described as a windmill blade comprising a hub portion on one end and a tip portion on the other end of the blade, the blade having a passage-way extending from near the hub portion to near the tip portion. The passageway of the windmill blade may extend into the interior hollow space of a support tower for the windmill blade. The passageway may extend out into the atmosphere. Other embodiments may be described as a windmill on a support tower with an interior hollow space, the windmill having a blade comprising a hub portion on one end and a tip portion the other end of the blade, the blade having a passageway extending from near the hub portion to near the tip portion, the passageway extending into the interior hollow space of the support tower, and the windmill having a turbine generator within the interior hollow space of the support tower. Other embodiments may be described as a windmill having a blade comprising a hub portion on one end and a tip portion on the other end of the blade, the blade having a passageway extending from near the hub portion to near the tip portion, and the windmill having a turbine generator near the passageway near the hub portion of the blade. Other embodiments may be described as a windmill having a blade comprising a hub portion on one end and a tip portion on the other end of the blade, the blade having a passageway extending from near the hub portion to near the tip portion, and the windmill having a turbine generator near the passageway near the tip portion of the blade. For example, a turbine generator may be “near” said passageway by being in the passageway or in an adjacent or nearby passage/opening in fluid communication with said passageway.

Although this invention has been described above with reference to particular means, materials and embodiments, it is to be understood that the invention is not limited to these disclosed particulars, but extends instead to all equivalents within the broad scope of the following claims.

1. A windmill blade comprising a hub portion on one end and a tip portion on the other end of the blade, the blade having a passage-way extending from near the hub portion to near the tip portion.

2. The windmill blade of claim 1 wherein said passageway extends into the interior hollow space of a support tower for the windmill blade.

3. The windmill blade of claim 1 wherein the passageway extends out into the atmosphere.

4. A windmill on a support tower with an interior hollow space, the windmill having a blade comprising a hub portion on one end and a tip portion the other end of the blade, the blade having a passageway extending from near the hub portion to near the tip portion, the passageway extending into the interior hollow space of the support tower, and the windmill having a turbine generator within the interior hollow space of the support tower.

5. A windmill having a blade comprising a hub portion on one end and a tip portion on the other end of the blade, the blade having a passageway extending from near the hub portion to near the tip portion, and the windmill having a turbine generator near the passageway near the hub portion of the blade.

6. A windmill having a blade comprising a hub portion on one end and a tip portion on the other end of the blade, the blade having a passageway extending from near the hub portion to near the tip portion, and the windmill having a turbine generator near the passageway near the tip portion of the blade.
